(19) United States
(12) Patent Application Publication
(10) Pub. No.: US 2025/0329105 A1
(43) Pub. Date: Oct. 23, 2025

(54) Coordination Between Independent Rendering Frameworks

(71) Applicant: Meta Platforms Technologies, LLC, Menlo Park, CA (US)

(72) Inventors: Walter J. LUH, Sunnyvale, CA (US); Mykyta LUTSENKO, San Mateo, CA (US); Jack WU, Tenafly, NJ (US); David TEITLEBAUM, Seattle, WA (US); Christopher LAW, San Francisco, CA (US); Dony GEORGE, Sunnyvale, CA (US); Jean-Francois MULE, San Francisco, CA (US); Artur KUSHKA, London (GB); Roman LESHCHINSKIY, London (GB); Tianyi YANG, San Mateo, CA (US); Gabriel P. LEVI, New York, NY (US); Jonathan MARINI, Brooklyn, NY (US); Derek YAU, Dublin, CA (US); David Michael WOODWARD, San Francisco, CA (US)

(21) Appl. No.: 18/189,616

(22) Filed: Mar. 24, 2023

Related U.S. Application Data
(60) Provisional application No. 63/383,266, filed on Nov. 11, 2022.

(51) Int. Cl. G06T 15/20; G06F 3/16; G06T 7/73; H04L 45/302

(52) U.S. Cl. CPC G06T 15/205; G06F 3/16; G06T 7/73; H04L 45/3065; G06T 2200/24

(57) ABSTRACT

Aspects of the present disclosure provide a “framework of frameworks” to help developers build artificial reality (XR) applications, including two-dimensional and three-dimensional content, using disparate rendering frameworks. These rendering frameworks can output data to the XR environment, but cannot talk to each other. Thus, some implementations can provide an intermediary framework to coordinate communication and rendering of content between the various systems. The intermediary framework can provide input routing by detecting an event with respect to a piece of content, and routing input data only to the system associated with that piece of content. The intermediary framework can also allow a node within an augment associated with one system to receive notifications of events in another node within the augment associated with another system.

### CROSS-REFERENCE TO RELATED APPLICATIONS

This application claims priority to U.S. Provisional Patent Application No. 63/383,266, filed Nov. 11, 2022, entitled “Coordination Between Independent Rendering Frameworks,” with Attorney Docket No. 3589-0217US00 and is related to U.S. patent application Ser. No. ______, filed Mar. 24, 2023, entitled “Coordination Between Independent Rendering Frameworks,” with Attorney Docket No. 3589-0217US02, both of which are herein incorporated by reference in their entirety.

### TECHNICAL FIELD

The present disclosure is directed to coordinating independent rendering frameworks by an intermediary framework.

### BACKGROUND

Artificial reality (XR) devices are becoming more prevalent. As they become more popular, the applications implemented on such devices are becoming more sophisticated. Augmented reality (AR) applications can provide interactive 3D experiences that combine images of the real-world with virtual objects, while virtual reality (VR) applications can provide an entirely self-contained 3D computer environment. For example, an AR application can be used to superimpose virtual objects over a video feed of a real scene that is observed by a camera. A real-world user in the scene can then make gestures captured by the camera that can provide interactivity between the real-world user and the virtual objects. Mixed reality (MR) systems can allow light to enter a user's eye that is partially generated by a computing system and partially includes light reflected off objects in the real-world. AR, MR, and VR experiences can be observed by a user through a head-mounted display (HMD), such as glasses or a headset.

XR experiences can include renderings of a variety of two-dimensional (2D) elements, such as flat virtual objects having x- and y-axis components (e.g., having lengths and heights). Concurrently or separately, XR experiences can include renderings of three-dimensional (3D) elements, such as 3D virtual objects having x-, y-, and z-axis components (e.g., having lengths, heights, and widths, i.e., depths). Rendering of 2D elements in an XR experience is conventionally handled by a dedicated 2D rendering framework, while rendering of 3D elements is handled by a dedicated 3D rendering framework, in conjunction with an XR engine, on an XR HMD.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for providing coordination between multiple independent frameworks by an intermediary framework.

FIG. 6 is a flow diagram illustrating a process used in some implementations of the present technology for providing input comprehension and routing to an independent rendering framework by an intermediary framework.

FIG. 7 is a block diagram illustrating an ecosystem of an intermediary framework in which some implementations of the present technology can operate.

FIG. 8 is a block diagram illustrating an application lifecycle for an intermediary framework that determines the relationship of system components to scene components.

FIG. 9 is a flow diagram illustrating an update loop for an intermediary framework according to some implementations.

FIG. 10A is a conceptual diagram illustrating an example view from an artificial reality device including two-dimensional and three-dimensional content handled by disparate, independent rendering frameworks.

FIG. 10B is a conceptual diagram illustrating an example view from an artificial reality device in which three-dimensional content is reactive to an event with respect to two-dimensional content.

FIG. 10C is a conceptual diagram illustrating an example view from an artificial reality device in which three-dimensional content is reactive to an interaction with respect to two-dimensional content.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to a “framework of frameworks” that helps developers build artificial reality (XR) applications, including two-dimensional (2D) and three-dimensional (3D) content, using existing rendering frameworks. These rendering frameworks can output data to the XR environment, but do not necessarily talk to each other. Thus, some implementations can provide a layer (i.e., an intermediary framework) to coordinate communication and rendering of content between the various systems. In some implementations, the intermediary framework can define how content inside a virtual object container (referred to herein as an “augment”) can work based on various system-level or developer-defined constraints, even though the content can originate from different systems. The intermediary framework can further provide input routing by detecting a change in the environment (e.g., a user pointing at a piece of content), and routing input data only to the system associated with that piece of content. The intermediary framework can also allow a node within an augment to subscribe to another node within the augment, such that when certain predefined events occur within the node, the other node can be notified.

For example, a first rendering framework associated with a first developer can be configured to render a 2D toggle switch in a first node of an augment, while a second rendering framework associated with a second developer can be configured to render a 3D virtual dog in a second node of the augment. An intermediary framework can act as a middleman between the first rendering framework and the second rendering framework, as they may be unable to communicate with each other independently. However, the second node can subscribe to changes in the 2D toggle switch in the first node via the intermediary framework, such that the intermediary framework can notify the second node if such an event occurs. Thus, upon detection of user input with respect to the 2D toggle switch in the first node (e.g., a gesture toward the 2D toggle switch), the intermediary framework can route the input to the first node to cause the 2D toggle switch to actuate. In response to the actuation of the 2D toggle switch in the first node, the intermediary framework can route a notification to the second node informing the second rendering framework of the event. Upon notification of the event, the second rendering framework can cause a corresponding event in the second node with respect to the 3D virtual dog, e.g., causing the virtual dog to do a trick.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or augment the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Implementations provide a specific technological improvement in the field of artificial reality in that they provide coordination between disparate, independent rendering frameworks responsible for managing 2D and/or 3D content in an XR environment on an XR device, such as an XR HMD. Because such rendering frameworks are unable to communicate with each other or communicate in different scripting languages, simultaneous display of their respective content without coordination could result in unwanted interactions between virtual objects, such as overlap, inappropriate sizes with respect to each other, etc. Thus, implementations can interface between the disparate rendering frameworks to allow for multiple pieces of content associated with different developers to be properly and appropriately rendered on the XR device. Some implementations can further provide input routing to rendering frameworks based on, e.g., a type of input, a location of the input, a command, etc., such that only a desired rendering framework is notified of the input and can make a corresponding change in its respective node. Thus, some implementations can save processing power by restricting input to only a particular rendering framework, without notifying rendering frameworks not intended for the input and/or without causing changes in other nodes based on the input that are unintended. Further, some implementations can notify other rendering frameworks of a change made by a particular rendering framework to allow them to make corresponding changes, if desired, which would otherwise be impossible by virtue of their lack of direct communication. Implementations are necessarily rooted in computing technology as they are tied to simultaneous 2D and 3D rendering, which is specific to the field of artificial reality devices.

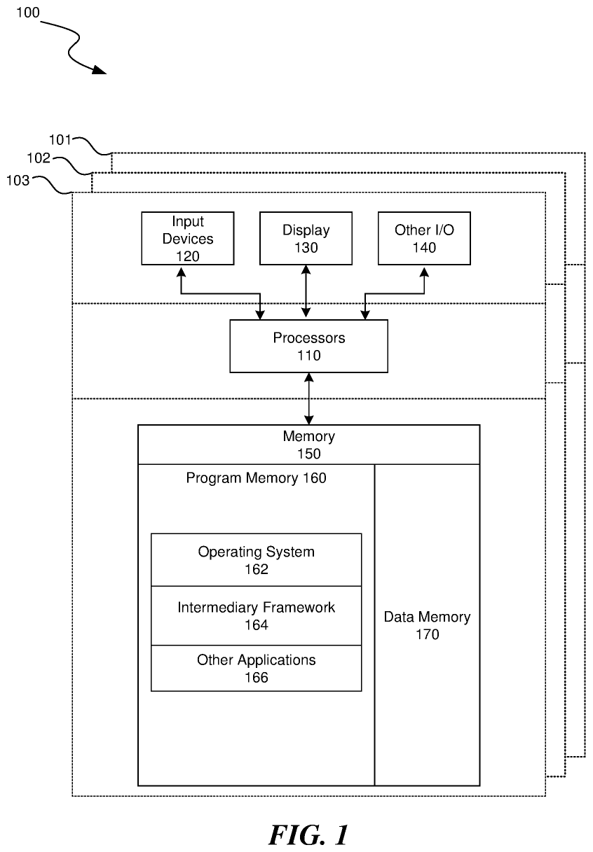

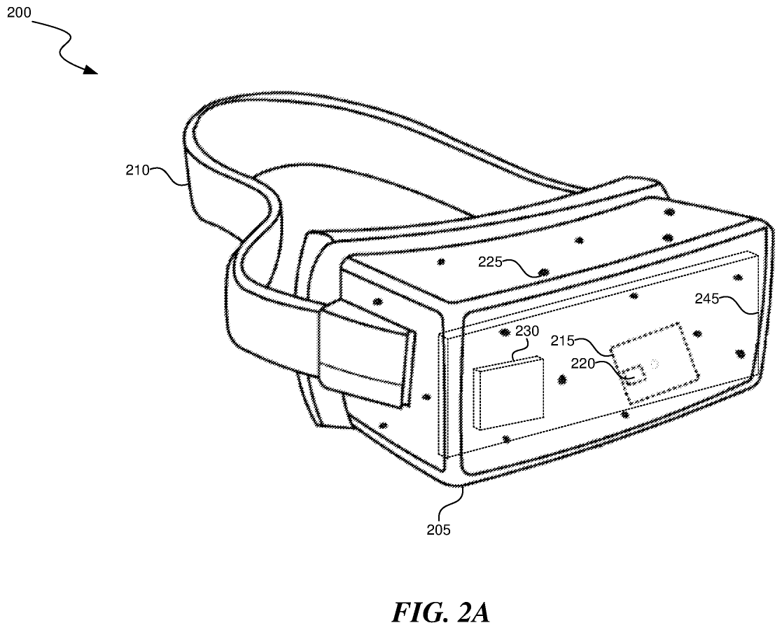

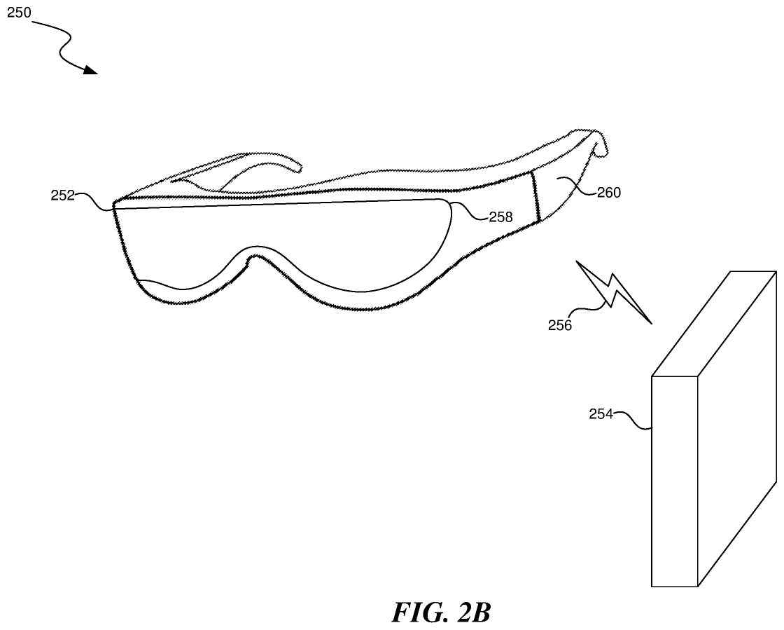

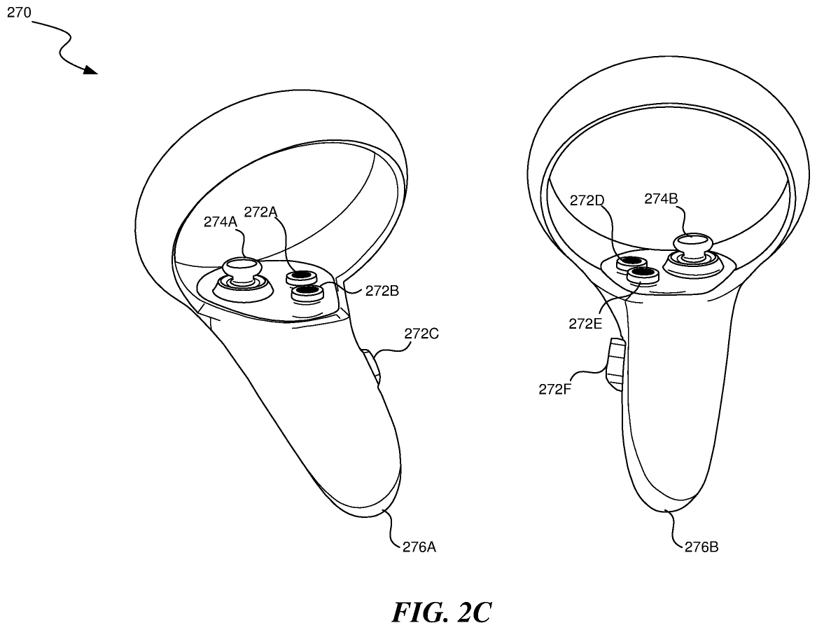

Several implementations are discussed below in more detail in reference to the figures. FIG. 1 is a block diagram illustrating an overview of devices on which some implementations of the disclosed technology can operate. The devices can comprise hardware components of a computing system 100 that can provide coordination between multiple independent rendering frameworks. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, intermediary framework 164, and other application programs 166. Memory 150 can also include data memory 170 that can include, e.g., rendering data, augment data, node data, content data, event data, registration data, notification data, routing data, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

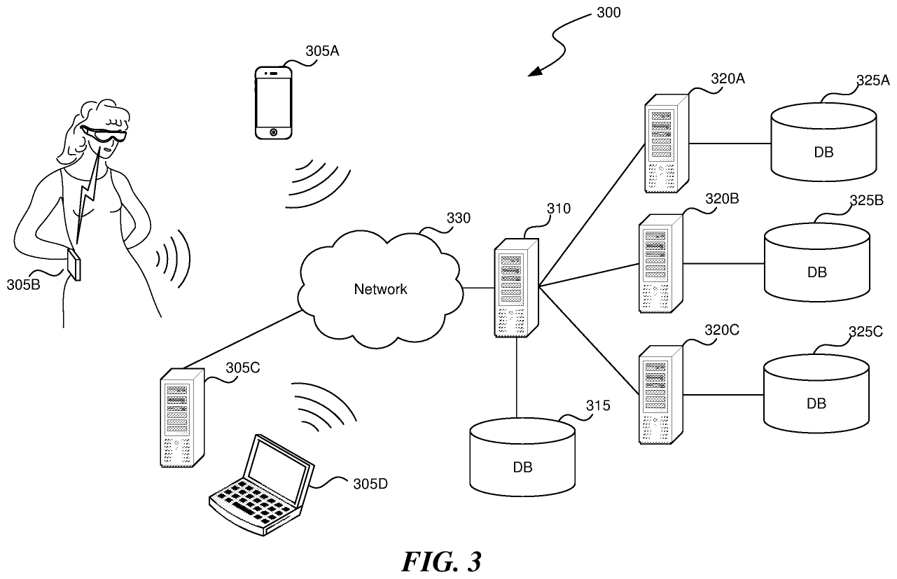

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

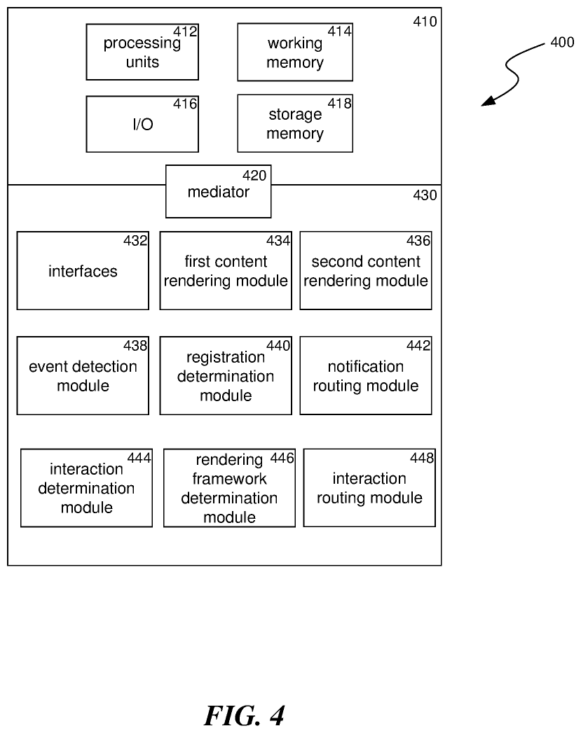

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for providing coordination between multiple independent rendering frameworks by an intermediary framework. Specialized components 430 can include first content rendering module 434, second content rendering module 436, event detection module 438, registration determination module 440, notification routing module 442, interaction determination module 444, rendering framework determination module 446, interaction routing module 448, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

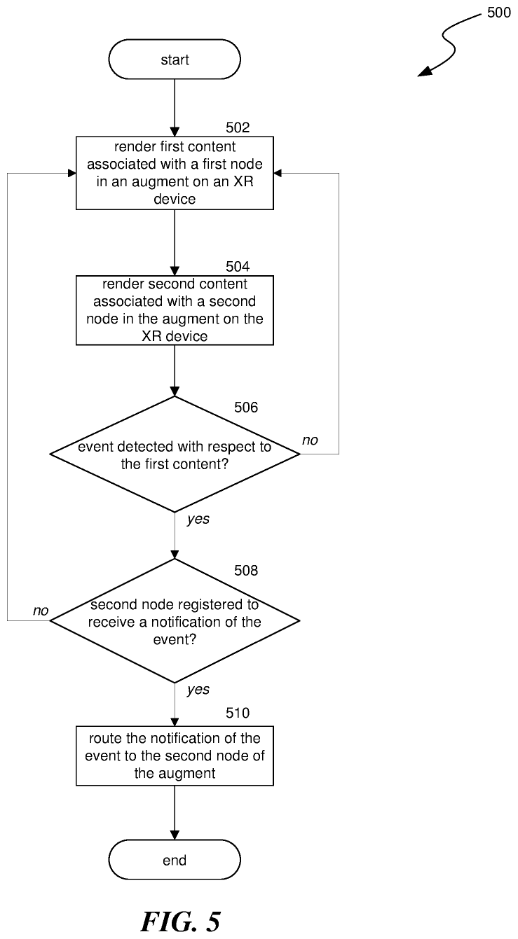

First content rendering module 434 can render first content associated with a first node of multiple nodes in an augment on an artificial reality (XR) device. In some implementations, the augment can define a bounding layout for the multiple nodes, e.g., the volume of space allocated to various nodes within the augment. The first node can be associated with a first rendering framework of multiple disparate, independent rendering frameworks. In some implementations, the multiple rendering frameworks can be unable to communicate directly with each other. For example, the multiple rendering frameworks can use different scripting languages to communicate with an intermediary framework. In some implementations, the multiple rendering frameworks can include a React framework, a Flutter framework, a Spark framework, etc. In some implementations, first content rendering module 434 can be configured to render 2D or 3D content. Further details regarding rendering first content associated with a first node in an augment on an XR device are described herein with respect to block 502 of FIG. 5.

Second content rendering module 436 can render second content associated with a second node of the multiple nodes in the augment on the XR device. The second node can be associated with a second rendering framework of the multiple independent rendering frameworks. In some implementations, second content rendering module 436 can be configured to render either 2D or 3D content. In some implementations, first content rendering module 434 and second content rendering module 436 can render different types of content (e.g., first content rendering module 434 can render 2D content, while second content rendering module 436 can render 3D content, or vice versa). In some implementations, the first content rendered by first content rendering module 434 and the second content rendered by second content rendering module 436 can have a 3D arrangement, regardless of the type of content rendered by each. Further details regarding rendering second content associated with a second node in an augment on an XR device are described herein with respect to block 504 of FIG. 5.

Event detection module 438 can detect an event with respect to the first content associated with the first node in the augment. In some implementations, the event can be input by a user of the XR device. The input can include, for example, selection of a virtual button, selection of a physical button (e.g., on a controller, such as on one of controllers 270), a gesture (e.g., pointing at the first content), etc. In some implementations, the event can be input by another user of another XR device, e.g., by sending a message to the user of the XR device. In some implementations, the event can be an environmental change with respect to the first content, e.g., a change in lighting surrounding the first content, a change in physical objects surrounding the first content, a movement of physical objects around the first content, a movement of virtual objects around the first content, etc. Further details regarding detecting an event with respect to the first content associated with the first node in the augment is described herein with respect to block 506 of FIG. 5.

Registration determination module 440 can determine whether the second node is registered to receive a notification of the event with respect to the first content associated with the first node. Registration determination module 440 can determine whether the second node is registered to receive the notification by, for example, querying a lookup table of nodes within the augment, event(s) that can occur within those nodes, and which (if any) other nodes are subscribed to those event(s). Further details regarding determining whether the second node is registered to receive a notification of an event with respect to the first content associated with the first node are described herein with respect to block 508 of FIG. 5.

Notification routing module 442 can, in response to registration determination module 440 determining that the second node is registered to receive the notification of the event with respect to the first content associated with the first node, route the notification of the event to the second node of the augment. In some implementations, the second rendering framework can modify the second content based on the notification. In some implementations, the notification of the event in the first node can cause an associated or corresponding event in the second node, e.g., a predetermined event in the second node based on the type of the event in the first node. Further details regarding routing a notification of an event to the second node of the augment are described herein with respect to block 510 of FIG. 5.

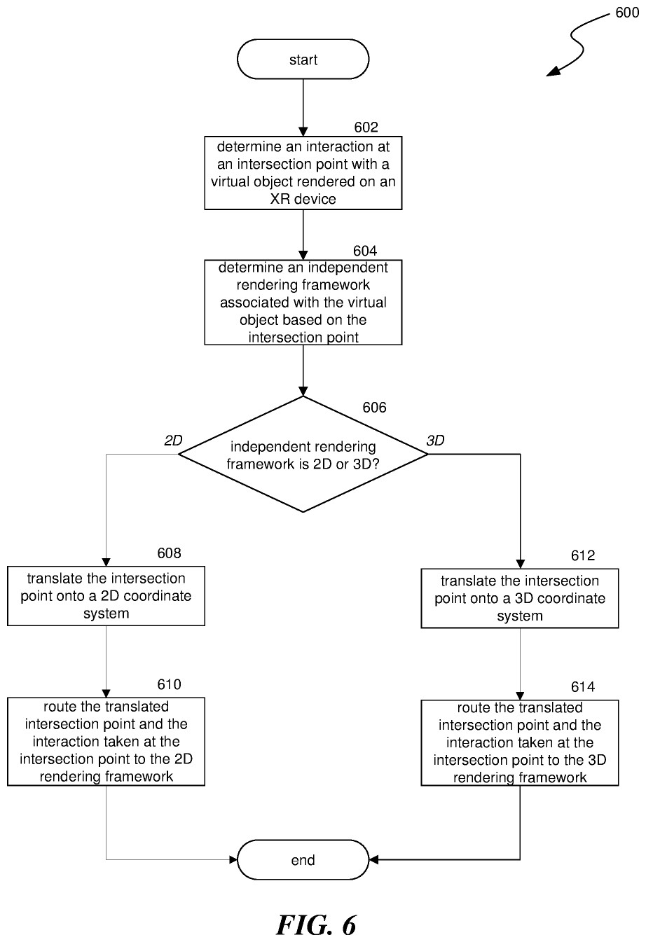

Interaction determination module 444 can determine an interaction corresponding to a detected position and orientation of input. The interaction can include, for example, a hand or finger gesture detected by the XR device, a controller gesture, selection of a physical button on a controller, a pointing operation with respect to a virtual ray cast into an XR environment, or any combination thereof. In some implementations in which the interaction includes a hand, finger, or controller gesture, interaction determination module 444 can convert, based on the detected position and orientation of the gesture, the input into a virtual ray cast in the XR environment. In some implementations, interaction determination module 444 can determine an intersection point of the virtual ray with a virtual object in the XR environment. In some implementations, interaction determination module 444 can determine a closest virtual object to the virtual ray, when the virtual ray does not intersect with a virtual object in the XR environment. Further details regarding determining an interaction at an intersection point with a virtual object rendered on an XR device are described herein with respect to block 602 of FIG. 6.

Rendering framework determination module 446 can determine an independent rendering framework associated with the virtual object with which interaction determination module 444 determined the interaction based on the intersection point. Rendering framework determination module 446 can determine the independent rendering framework associated with the virtual object based on, for example, metadata associated with the virtual object. The metadata can include, for example, an explicit field identifying the independent rendering framework, a type of the virtual object (e.g., 2D, 3D, image, video, animation, etc.), a scripting language used to render the virtual object (which can be unique to a particular rendering framework), or any combination thereof. Further details regarding determining an independent rendering framework associated with a virtual object based on an intersection point are described herein with respect to block 604 of FIG. 6.

Rendering framework determination module 446 can further determine whether the independent rendering framework is a 2D or 3D rendering framework. In some implementations, rendering framework determination module 446 can determine whether the independent rendering framework is a 2D or 3D rendering framework based on metadata associated with the virtual object, such as an explicit field identifying the independent rendering framework and/or indicating whether the independent rendering framework renders 2D or 3D virtual objects, a type of the virtual object (e.g., 2D or 3D), a scripting language used to render the virtual object, properties of the virtual object (e.g., dimensions of the virtual object), or any combination thereof. Further details regarding determining whether an independent rendering framework is a 2D rendering framework or a 3D rendering framework are described herein with respect to block 606 of FIG. 6.

If rendering framework determination module 446 determines that the independent rendering framework is a 2D rendering framework, interaction routing module 448 can translate the intersection point of the interaction with the virtual object onto a 2D coordinate system, such that the 2D rendering framework can ascertain where on the virtual object the interaction took place. Interaction routing module 448 can then route the translated intersection point and the interaction taken at the intersection point (e.g., a tapping motion with a hand, a selection with a controller, etc.) to the 2D rendering framework. Further details regarding translating an intersection point of an interaction with a virtual object onto a 2D coordinate system and routing the translated intersection point and the interaction to a 2D rendering framework are described herein with respect to blocks 608 and 610 of FIG. 6, respectively. If rendering framework determination module 446 determines that the independent rendering framework is a 3D rendering framework, interaction routing module 448 can translate the intersection point onto a 3D coordinate system, such that the 3D rendering framework can understand where on the virtual object the interaction took place. For example, the various artificial reality device systems can use different coordinate systems from that of the 3D rendering framework, which may require input received in one coordinate system to be translated to that of the 3D rendering framework. Interaction routing module 448 can then route the translated intersection point and the interaction taken at the intersection point to the 3D rendering framework. Further details regarding translating an intersection point of an interaction with a virtual object onto a 3D coordinate system and routing the translated intersection point and the interaction to a 3D rendering framework are described herein with respect to blocks 612 and 614 of FIG. 6, respectively.

Although specialized components 430 are illustrated as including all of first content rendering module 434, second content rendering module 436, event detection module 438, registration determination module 440, notification routing module 442, interaction determination module 444, rendering framework determination module 446, and interaction routing module 448, it is contemplated that one or more of specialized components 430 can be omitted. For example, to perform coordination of communication between independent rendering frameworks (e.g., as in process 500 of FIG. 5), it is contemplated that, in some implementations, interaction determination module 444, rendering framework determination module 446, and/or interaction routing module 448 can be omitted from specialized components 430. In another example, to perform input routing and comprehension for independent rendering frameworks (e.g., as in process 600 of FIG. 6), it is contemplated that, in some implementations, first content rendering module 434, second content rendering module 436, event detection module 438, registration determination module 440, and/or notification routing module 442 can be omitted from specialized components 430.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations for providing coordination between multiple independent rendering frameworks by an intermediary framework. In some implementations, the intermediary framework can use a C++ language. In some implementations, process 500 can be performed as a response to a user request to simultaneously render content associated with disparate, independent rendering frameworks. In some implementations, process 500 can be performed as a response to activation, powering on, and/or donning of an XR device. In some implementations, process 500 can be performed as a response to the launching of applications associated with disparate, independent rendering frameworks. In some implementations, process 500 can be performed by an intermediary framework, e.g., intermediary framework 164 of FIG. 1. In some implementations, some or all of the steps of process 500 can be performed by one or more XR devices in an XR system, such as a head-mounted display (HMD), processing components in operable communication with an HMD, etc.

At block 502, process 500 can render first content associated with a first node in an augment on an XR device. In some implementations, the augment can include multiple nodes. The first node can be associated with a first rendering framework of multiple independent rendering frameworks. In some implementations, the first rendering framework can be a two-dimensional (2D) rendering framework of the multiple independent rendering frameworks. In some implementations, each node of the augment can be associated with a different independent rendering framework. In some implementations, the augment can define a bounding layout for the multiple nodes, e.g., the size, position, orientation, volume with respect to other nodes, etc., that can be occupied by respective content. In some implementations, the augment itself can have a maximum volume on a display of the XR device, and the display can include multiple augments.

At block 504, process 500 can render second content associated with a second node of the multiple nodes in the augment on the XR device. The second node can be associated with a second rendering framework of the multiple independent rendering frameworks. In some implementations, the second rendering framework can be a three-dimensional (3D) rendering framework of the multiple independent rendering frameworks. In some implementations, the first rendering framework and the second rendering framework can be associated with different developers. In some implementations, the intermediary framework can communicate with the first rendering framework and the second rendering framework in different scripting languages. For example, the intermediary framework can communicate in the scripting languages used by the first rendering framework and the second rendering framework, although their respective scripting languages may not be known or used by each other.

The first content and the second content can include any type of one or more presentable objects, such as virtual objects, audio objects, video objects, visual effects, etc. The first content and the second content can be two-dimensional (2D) content and/or three-dimensional (3D) content. In some implementations, the first content and the second content can be different types of content, e.g., the first content can be 2D content, while the second content can be 3D content, or vice versa. Thus, for example, the first rendering framework can be configured to render 2D content, and the second rendering framework can be configured to render 3D content, or vice versa. In some implementations, the first content and the second content can be the same type of content, e.g., both 2D content or both 3D content. In some implementations, the first content and the second content can be attached to anchors established for a real-world environment of the user of the XR device, as described further herein.

In some implementations, the first content and the second content can be rendered within the bounding layout of the augment according to constraints enforced by the intermediary framework. The constraints can be system-level constraints (i.e., established by a platform associated with the XR device) or developer-level constraints (i.e., established by a developer of a respective rendering framework). For example, the constraints can include one or more of a size of the augment, a size of the augment that is allocated to the first node, a size of the augment that is allocated to the second node, the size of the augment that is allocated to the first node relative to the size of the augment that is allocated to the second node, how the first content can interact with the second content, how the first content is positioned with respect to the second content, or any combination thereof.

Although described herein as rendering first content and second content, it is contemplated that process 500 can render any number of content items with respect to any number of nodes in an augment. Alternatively or additionally, it is contemplated that process 500 can render any number of content items with respect to any number of nodes across multiple augments, i.e., multiple nodes can be present in multiple augments on a display of the XR HMD.

At block 506, process 500 can determine whether an event has been detected with respect to the first content associated with the first node in the augment. The event can be any change in the first node associated with the first content. In some implementations, the event can be an action in the first node. For example, the event can be input received by the XR device, e.g., through one or more of a voice command, a gesture, a selection of a physical button on the XR device, a selection of a virtual button displayed on the XR device, or any combination thereof, by a user of the XR device. When the event is input received by the XR device, process 500 can further determine that the input corresponds to the first content associated with the first node in the augment (e.g., a gesture toward the first content, a selection of the first content, a command including a reference to the first content, etc.). In response to determining that the input corresponds to the first content associated with the first node in the augment, process 500 can route the input to the first node of the augment, such that the first rendering framework can cause the event with respect to the first content in the first node based on the input. In some implementations, the event can be based on a timer.

In some implementations, the event can be caused by another user, such as a user of another XR device or other computing device, e.g., by sending a message to a user of the XR device. In some implementations, the event can be an environmental change in the real-world environment of the user of the XR device. For example, the environmental change can be detection of a particular physical object around or near the first content, detection of movement around or near the first content, detection of ambient lighting around the first content, etc.

If no event is detected with respect to the first content, process 500 can return to block 502. If an event is detected with respect to the first content, process 500 can continue to block 508. At block 508, process 500 can determine whether the second node is registered to receive a notification of the event with respect to the first content associated with the first node. The second node can register to receive the notification of the event in the first node by, for example, transmitting a request to the intermediary framework, and in some implementations, the registration can be automatic. In some implementations, process 500 can verify that the second node is able to register for the notification based on rules and/or permissions maintained by the first rendering framework (e.g., by communicating the request to the first rendering framework), and/or based on system-level rules and/or permissions maintained by the intermediary framework.

If the second node is not registered to receive the notification of the event with respect to the first content associated with the first node, process 500 can return to block 502. If the second node is registered to receive the notification of the event with respect to the first content associated with the first node, process 500 can proceed to block 510. At block 510, in response to determining that the second node is registered to receive the notification of the event with respect to the first content associated with the first node, process 500 can route the notification of the event to the second node of the augment associated with the second rendering framework.

In some implementations, an action performed in the first node can cause a corresponding action in the second node. For example, the second rendering framework can modify the second content based on the notification of the event. In some implementations, the second rendering framework can visually modify the second content (e.g., change its size, shape, color, animation, etc.). In some implementations, the second rendering framework can modify a state of the second content, such as by changing the second content from an active state to an inactive state or vice versa, changing the second content from a focused state to an unfocused state or vice versa, changing the second content from a foreground state to a background state or vice versa, changing the second content from a displayed state to a nondisplayed state or vice versa, changing the second content from a maximized state to a minimized state (e.g., as an icon) or vice versa, etc. In some implementations, the second rendering framework can modify a behavior of the second content, e.g., how the second content reacts or does not react to input or interaction, how the second content reacts or does not react to changes in other nodes or input received at other nodes (either managed by the second rendering framework or by another independent rendering framework), etc.

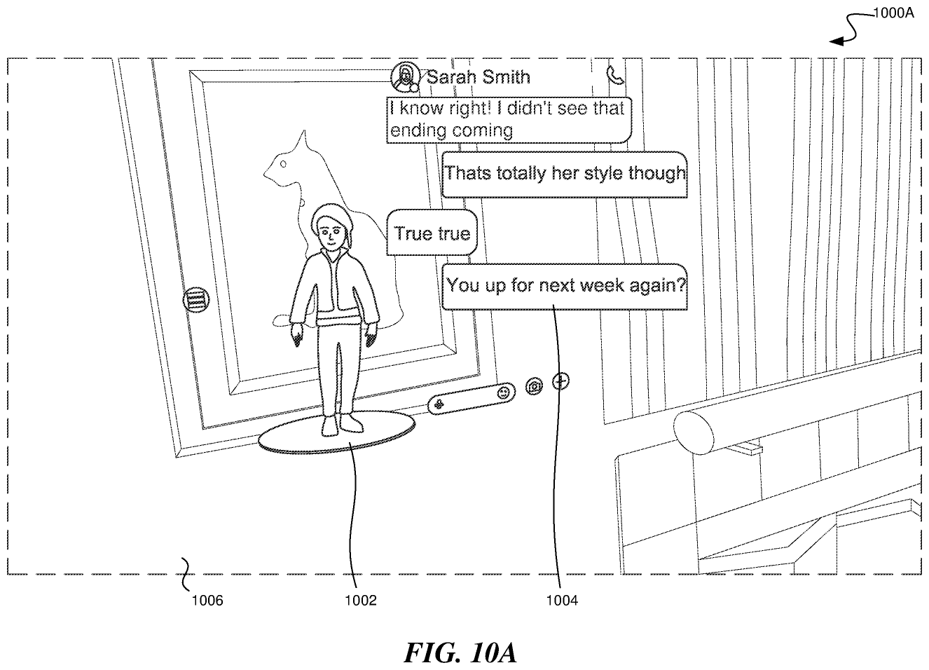

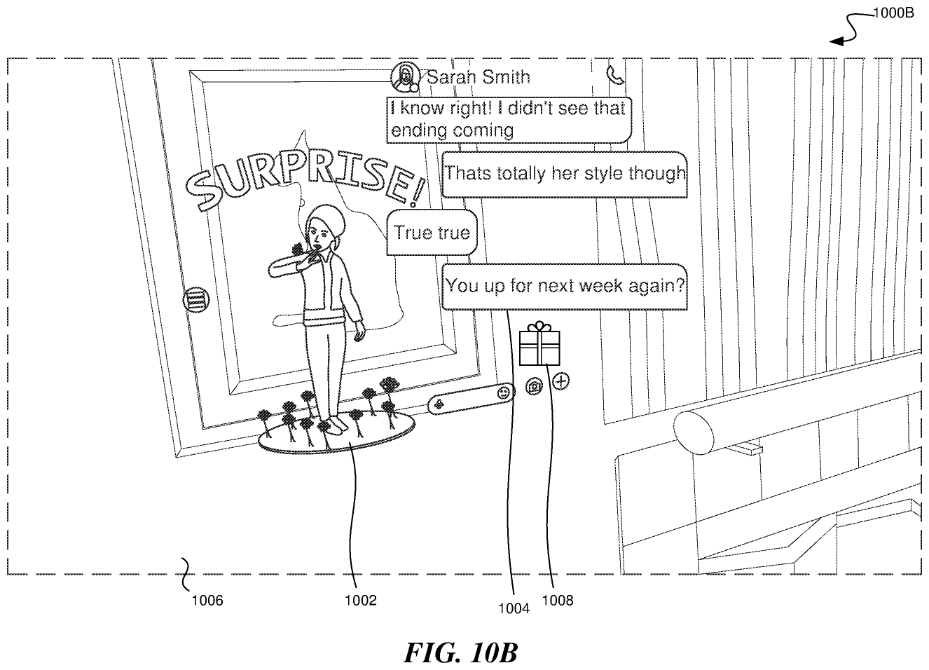

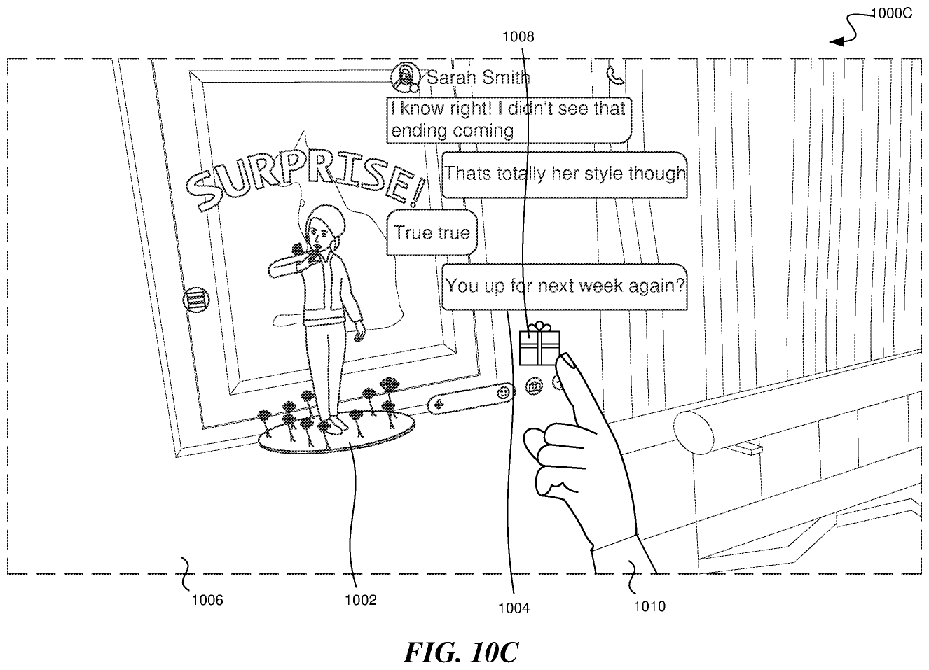

In some implementations, in response to the second rendering framework modifying the second content, the first rendering framework can modify the first content in accordance with the bounding layout of the augment. For example, in response to the bounding layout of the augment being changed in accordance with the modification of the second content (e.g., a volume of the augment dedicated to the first node changes based on the modification of the second content in the second node), the first rendering framework can modify the first content in the first node (e.g., by increasing or decreasing the size of the first content in the first node of the augment). An exemplary action performed in a first node and corresponding action in the second node are described herein with respect to FIGS. 10A and 10B.

FIG. 6 is a flow diagram illustrating a process 600 used in some implementations of the present technology for providing input comprehension and routing to an independent rendering framework by an intermediary framework. In some implementations, the intermediary framework can use a C++ language. In some implementations, process 600 can be performed as a response to a detected interaction of a user by an artificial reality (XR) device. In some implementations, process 600 can be performed by an intermediary framework, e.g., intermediary framework 164 of FIG. 1. In some implementations, some or all of the steps of process 600 can be performed by one or more XR devices in an XR system, such as a head-mounted display (HMD), processing components in operable communication with an XR HMD, etc.

At block 602, process 600 can determine an interaction, corresponding to a detected position and orientation of input, at an intersection point with a virtual object rendered on an XR device. For example, the interaction can be input received by the XR device, e.g., through one or more of a voice command, a selection of a physical button on the XR device or a controller (e.g., controller 276A and/or controller 276B of FIG. 2C), a controller gesture, a selection of a virtual button displayed on the XR device, or any combination thereof, by a user of the XR device. For example, the interaction can be a selecting action, a hovering action, a pointing action, a button press, a scrolling action, etc. In some implementations, the input can be an environmental change detected by the XR device in a real-world environment surrounding the XR device. For example, the environmental change can be detection of a particular physical object around or near a virtual object, detection of movement around or near the virtual object, detection of ambient lighting around the virtual object, etc.

In some implementations, the interaction can include a gesture made by one or more fingers and/or one or both hands of the user of the XR device. In some implementations, process 600 can detect the gesture via one or more cameras integral with or in operable communication with the XR device, such as cameras positioned on an XR HMD pointed away from the user's face. For example, process 600 can capture one or more images of the user's hand and/or fingers in front of the XR device while making a particular gesture. Process 600 can perform object recognition on the captured image(s) to identify a user's hand and/or fingers making a particular gesture (e.g., pointing, snapping, tapping, pinching, etc.). In some implementations, process 600 can use a machine learning model to identify the gesture from the image(s). For example, process 600 can train a machine learning model with images capturing known gestures, such as images showing a user's hand making a fist, a user's finger pointing, a user making a sign with her fingers, a user placing her pointer finger and thumb together, etc. Process 600 can identify relevant features in the images, such as edges, curves, and/or colors indicative of fingers, a hand, etc., making a particular gesture. Process 600 can train a machine learning model using these relevant features of known gestures. Once the model is trained with a sufficient data, process 600 can use the trained model to identify relevant features in newly captured image(s) and compare them to the features of known gestures. In some implementations, process 600 can use the trained model to assign a match score to the newly captured image(s), e.g., 80%. If the match score is above a threshold, e.g., 70%, process 600 can classify the motion captured by the image(s) as being indicative of a particular gesture. In some implementations, process 600 can further receive feedback from the user regarding whether the identification of the gesture was correct, and update the trained model accordingly.

In some implementations, process 600 can determine one or more motions associated with a predefined gesture by analyzing a waveform indicative of electrical activity of the one or more muscles of the user using one or more wearable electromyography (EMG) sensors, such as on an EMG wristband in operable communication with the XR HMD. For example, the one or more motions can include movement of a hand, movement of one or more fingers, etc., when at least one of the one or more EMG sensors is located on or proximate to the wrist, hand, and/or one or more fingers. Process 600 can analyze the waveform captured by one or more EMG sensors worn by the user by, for example, identifying features within the waveform and generating a signal vector indicative of the features. In some implementations, process 600 can compare the signal vector to known gesture vectors stored in a database to identify if any of the known gesture vectors matches the signal vector within a threshold, e.g., is within a threshold distance of a known threshold vector (e.g., the signal vector and a known gesture vector have an angle therebetween that is lower than a threshold angle). If a known gesture vector matches the signal vector within the threshold, process 600 can determine the gesture associated with the vector, e.g., from a look-up table.

In some implementations, process 600 can detect a gesture based on motion data collected from one or more sensors of an inertial measurement unit (IMU), integral with or in operable communication with the XR HMD (e.g., in a smart device, such as a smart wristband, or controller in communication with the XR HMD), to identify and/or confirm one or more motions of the user indicative of a gesture. The measurements may include the non-gravitational acceleration of the device in the x, y, and z directions; the gravitational acceleration of the device in the x, y, and z directions; the yaw, roll, and pitch of the device; the derivatives of these measurements; the gravity difference angle of the device; and the difference in normed gravitational acceleration of the device. In some implementations, the movements of the device may be measured in intervals, e.g., over a period of 5 seconds.

For example, when motion data is captured by a gyroscope and/or accelerometer in an IMU of a controller (e.g., controller 276A and/or controller 276B of FIG. 2C), process 600 can analyze the motion data to identify features or patterns indicative of a particular gesture, as trained by a machine learning model. For example, process 600 can classify the motion data captured by the controller as a tapping motion based on characteristics of the device movements. Exemplary characteristics include changes in angle of the controller with respect to gravity, changes in acceleration of the controller, etc.

Alternatively or additionally, process 600 can classify the device movements as particular gestures based on a comparison of the device movements to stored movements that are known or confirmed to be associated with particular gestures. For example, process 600 can train a machine learning model with accelerometer and/or gyroscope data representative of known gestures, such as pointing, snapping, pinching, tapping, clicking, etc. Process 600 can identify relevant features in the data, such as a change in angle of the device within a particular range, separately or in conjunction with movement of the device within a particular range. When new input data is received, i.e., new motion data, process 600 can extract the relevant features from the new accelerometer and/or gyroscope data and compare it to the identified features of the known gestures of the trained model. In some implementations, process 600 can use the trained model to assign a match score to the new motion data, and classify the new motion data as indicative of a particular gesture if the match score is above a threshold, e.g., 75%. In some implementations, process 600 can further receive feedback from the user regarding whether an identified gesture is correct to further train the model used to classify motion data as indicative of particular gestures.

A “machine learning model,” as used herein, refers to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include: neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the machine learning model can be a neural network with multiple input nodes that receive data about hand and/or finger positions or movements. The input nodes can correspond to functions that receive the input and produce results. These results can be provided to one or more levels of intermediate nodes that each produce further results based on a combination of lower level node results. A weighting factor can be applied to the output of each node before the result is passed to the next layer node. At a final layer, (“the output layer,”) one or more nodes can produce a value classifying the input that, once the model is trained, can be interpreted as wave properties. In some implementations, such neural networks, known as deep neural networks, can have multiple layers of intermediate nodes with different configurations, can be a combination of models that receive different parts of the input and/or input from other parts of the deep neural network, or are convolutions or recurrent-partially using output from previous iterations of applying the model as further input to produce results for the current input.

A machine learning model can be trained with supervised learning, where the training data includes hand and/or finger positions or movements as input and a desired output, such as an identified gesture. A representation of hand and/or finger positions or movements can be provided to the model. Output from the model can be compared to the desired output for that input and, based on the comparison, the model can be modified, such as by changing weights between nodes of the neural network or parameters of the functions used at each node in the neural network (e.g., applying a loss function). After applying the input in the training data and modifying the model in this manner, the model can be trained to evaluate new data. Similar training procedures can be used for the various machine learning models discussed above.

It is contemplated that process 600 can identify any suitable gesture that can be associated with or indicative of an intention to interact with a virtual object. For example, process 600 can identify a pinch gesture, a tap gesture, a pointing gesture, a circling gesture, an underlining gesture, a movement in a particular direction, etc. In some implementations, process 600 can alternatively or additionally receive input associated with or indicative of an intention to interact with the virtual object from an input device, such as one or more handheld controllers (e.g., controller 276A and/or controller 276B of FIG. 2C) that allow the user to interact with the virtual object presented by an XR HMD. The controllers can include various buttons and/or joysticks that a user can actuate to provide selection input and interact with the virtual object.

In association with identifying a gesture, process 600 can determine where in the XR environment the gesture is made with reference to the virtual object. For example, process 600 can iteratively track the position of the user's hand (e.g., from one or more images), as it relates to a coordinate system of the XR environment. Process 600 can determine a position and/or pose of the hands in the real-world environment relative to the XR device using one or more of the techniques described above, which can then be translated into the XR device's coordinate system. Once on the XR device's coordinate system, process 600 can determine a virtual location in the XR environment of the gesture relative to a location of the virtual object on the XR device's coordinate system, e.g., proximate to or touching the virtual object.

In some implementations, process 600 can convert, based on the detected position and orientation of the input, the input into a virtual ray cast in three-dimensional (3D) space in an XR environment. The virtual ray can be a vector extending from a user's virtual hand in the XR environment (which can be tracking the user's physical hand in the real-world environment, a controller, etc.) away from the user into the XR environment. Process 600 can determine the intersection point, in the XR environment, in which the virtual ray would intersect with the virtual object rendered on the XR device. Process 600 can make this determination by comparing the trajectory of the ray in the XR environment to a position of the virtual object within the XR environment (e.g., hit tracing). In some implementations, process 600 can alternatively determine which virtual object is closest to intersection with the virtual ray, when the virtual ray does not have an intersection point with a virtual object.

In some implementations, the virtual object can be content associated with a node, of multiple nodes, in an augment on the XR device, the node being associated with an independent rendering framework. In some implementations, the virtual object can be any visual object displayed on the XR device, such as a static visual object, an animated visual object, a video object, visual effects, etc. In some implementations, other content can be associated with other nodes of the multiple nodes in the augment on the XR device, and the other nodes can be associated with other independent rendering frameworks. In other words, in some implementations, content managed by different independent rendering frameworks can be included at separate nodes within a same augment on the XR device. In some implementations, however, content managed by different or the same independent rendering frameworks can be included at separate nodes within different augments on the XR device. In some implementations, the augment can define a bounding layout for the multiple nodes, e.g., the size, position, orientation, volume with respect to other nodes, etc., that can be occupied by respective content. In some implementations, the augment itself can have a maximum volume on a display of the XR device, and the display can include multiple augments.

In some implementations, the virtual object can be first content associated with a first node, of multiple nodes, in an augment on the XR device, the first node being managed by a first independent rendering framework. The augment can include second content associated with a second node, of the multiple nodes, the second node being managed by a second independent rendering framework. In some implementations, the first and second independent rendering frameworks can be associated with different developers. In some implementations, the first content can be 2D content and the second content can be 3D content, or vice versa. In some implementations, both the first content and the second content can be 2D content, or both the first content and the second content can be 3D content. In some implementations, although the first content can be a visual object, the second content does not have to be visual content, and can be, for example, audio content, haptics content, etc.

In some implementations, the first content and the second content can be attached to the XR environment relative to spatial anchors established for a real-world environment surrounding the XR device. The spatial anchors can be points in the real-world environment that the XR device can detect and follow across sessions, such that positions of the first content and the second content can persist relative to the real-world environment across sessions. As long as the real-world environment does not change, the spatial anchors can persist and be shareable to other XR devices accessing XR applications from within the real-world environment. Thus, XR devices within a common real-world environment can have common reference points. In some implementations, the XR device can capture and/or create the spatial anchors for the real-world environment by, for example, scanning the real-world environment, identifying unmovable features (or features unlikely to be moved) in the real-world environment, and saving them as reference points. In some implementations, the XR device can obtain previously captured spatial anchors from local storage, from another XR device, and/or from a platform computing system or other computing system on the cloud.

In some implementations, the first independent rendering framework and the second independent rendering framework can communicate with the intermediary framework via different scripting languages. For example, the intermediary framework can communicate in the scripting language used by the first rendering framework, as well as the scripting language used by the second rendering framework. However, the scripting language used by the first rendering framework may not be known or used by the second rendering framework, and/or vice versa.

In some implementations, the first content and the second content can be rendered within the bounding layout according to constraints enforced by the intermediary framework. The constraints can be system-level constraints (i.e., established by a platform associated with the XR device) or developer-level constraints (i.e., established by a developer of a respective rendering framework). In some implementations, the constraints can include one or more of a size of the augment, a size of the augment that is allocated to the first node, a size of the augment that is allocated to the second node, the size of the augment that is allocated to the first node relative to the size of the augment that is allocated to the second node, how the first content can interact with the second content, or any combination thereof. Although described herein with respect to first and second content associated with first and second rendering frameworks, respectively, it is contemplated that the embodiments described herein can be implemented with respect to any number of content items associated with any number of independent rendering frameworks.

At block 604, process 600 can determine an independent rendering framework associated with the virtual object based on the intersection point. In some implementations, process 600 can determine the independent rendering framework associated with the virtual object by analyzing metadata associated with the virtual object, and identifying the independent rendering framework managing the virtual object from the metadata. In some implementations, process 600 can determine the independent rendering framework associated with the virtual object based on the scripting language in which the independent rendering framework is communicating with the intermediary framework. The independent rendering framework can be of multiple independent rendering frameworks managing content at nodes of the augment or at nodes of other augments. The multiple independent rendering frameworks can include two-dimensional (2D) rendering frameworks and/or 3D rendering frameworks. The 2D rendering frameworks can manage rendering of 2D content, while the 3D rendering frameworks can manage rendering of 3D content.

At block 606, process 600 can determine whether the independent rendering framework is a 2D rendering framework or a 3D rendering framework. In some implementations, process 600 can determine whether the independent rendering framework is a 2D rendering framework or a 3D rendering framework based on metadata of the virtual object identifying the virtual object as a 2D or 3D virtual object. In some implementations, process 600 can determine whether the independent rendering framework is a 2D or 3D rendering framework based on characteristics of the virtual object. For example, if the virtual object has properties in the x-, y-, and z-dimensions, process 600 can determine that the independent rendering framework is a 3D rendering framework. Conversely, if the virtual object has properties only in the x- and y-dimensions, process 600 can determine that the independent rendering framework is a 2D rendering framework. Although described herein as being either a 2D or 3D rendering framework, it is contemplated that the independent rendering framework can be an integration framework for rendering both 2D and 3D elements. Further details regarding an integration framework for 2D and 3D elements are described in U.S. patent application Ser. No. 18/167,478, filed Feb. 10, 2023, entitled “Integration Framework for Two-Dimensional and Three-Dimensional Elements in an Artificial Reality Environment,” which is herein incorporated by reference in its entirety. In such implementations, process 600 can determine whether the virtual object rendered by the integration framework is a 2D or 3D element, then proceed to block 608 if the virtual object is a 2D element, or proceed to block 612 if the virtual object is a 3D element.

If process 600 determines that the independent rendering framework is a 2D rendering framework, process 600 can proceed to block 608. At block 608, process 600 can translate the intersection point onto a 2D coordinate system. For example, process 600 can translate the intersection point of the ray with the 2D virtual object into a point having x- and y-coordinates, i.e., length and width coordinates on the 2D virtual object in the XR environment. At block 610, process 600 can route the translated intersection point and the interaction taken at the intersection point to the 2D rendering framework, which can include position and orientation information indicative of a particular motion, gesture, pose, etc. In some implementations, process 600 can translate the interaction taken at the intersection point into a format usable by the 2D rendering framework, such as by equating a tapping motion into a mouse click that is understandable within the 2D coordinate system of the 2D rendering framework.

If process 600 determines that the independent rendering framework is a 3D rendering framework, process 600 can proceed to block 612. At block 612, process 600 can translate the intersection point onto a 3D coordinate system. For example, process 600 can translate the intersection point of the ray with the 3D virtual object into a point having x-, y-, and z-coordinates, i.e., length, width, and depth coordinates on the 3D virtual object in the XR environment. At block 614, process 600 can route the translated intersection point and the interaction taken at the intersection point to the 3D rendering framework, which can include position and orientation information indicative of a particular motion, gesture, pose, etc. In some implementations, process 600 can translate the interaction taken at the intersection point into a format usable by the 3D rendering framework, such as by equating a pinch-and-move gesture into a grab-and-drag of the 3D virtual object in the 3D coordinate system of the 3D rendering framework.

In some implementations, the independent rendering framework can cause an event with respect to the virtual object based on the input, such as a visual, audible, and/or haptics modification with respect to the virtual object. In some implementations, the event can include a change in state of the virtual object (e.g., displayed or not displayed, focused or unfocused, foreground or background, maximized or minimized, etc.). In some implementations, the event can include a change in behavior of the virtual object (e.g., how the virtual object reacts to input, how the virtual object interacts with other virtual objects, etc.).

In some implementations, process 600 can determine that another node (or multiple other nodes) are registered to receive a notification of the event, caused in a node of the augment by the input, with respect to the virtual object. Another node can register to receive the notification of the event by, for example, transmitting a request to the intermediary framework, and in some implementations, the registration can be automatic. In some implementations, process 600 can verify that the other node is able to register for the notification based on rules and/or permissions maintained by the independent rendering framework (e.g., by communicating the request to the independent rendering framework), and/or based on system-level rules and/or permissions maintained by the intermediary framework.

In response to determining that another node is registered to receive the notification of the event with respect to the virtual object, process 600 can route the notification of the event to the other node of the augment (or another node in another augment) associated with another rendering framework. The other rendering framework associated with content in the other node can modify the content based on the notification. In some implementations, in response to the other rendering framework modifying the other content, the independent rendering framework can modify the virtual object according to the bounding layout of the augment. For example, the independent rendering framework can modify the size of the virtual object relative to a size change of the other content, or based on other constraints as described herein. An exemplary action performed in one node and corresponding action being taken in another node are described herein with respect to FIGS. 10A-10C.

In some implementations, process 600 can be performed in multiple (i.e., two or more) iterations as further interactions occur. For example, process 600 can determine a first interaction with a first virtual object associated with a 2D rendering framework and perform blocks 608-610, then determine a second interaction with a second virtual object associated with a 3D rendering framework and perform blocks 612-614, or vice versa. In another example, process 600 can determine multiple consecutive interactions with the same or different virtual objects associated with the same or different 2D rendering frameworks, and/or multiple consecutive interactions with the same or different virtual objects associated with the same or different 3D rendering frameworks. Further, as noted above, the implementations described herein can be similarly applied to integration frameworks for rendering both 2D and 3D content.

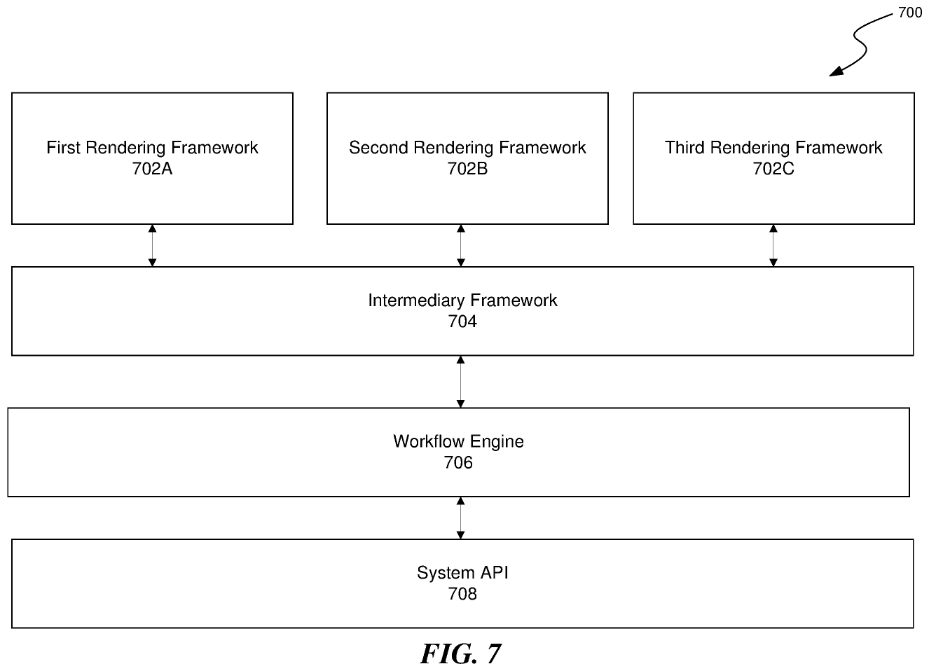

FIG. 7 is a block diagram illustrating an ecosystem 700 of an intermediary framework 704 in which some implementations of the present technology can operate. In some implementations, intermediary framework 704 can be similar to intermediary framework 164 of FIG. 1. Intermediary framework 704 can be in operable communication with first rendering framework 702A, second rendering framework 702B, and third rendering framework 702C. First rendering framework 702A, second rendering framework 702B, and third rendering framework 702C can include two-dimensional (2D) rendering frameworks for rendering 2D content, and/or three-dimensional (3D) rendering frameworks for rendering 3D content. Although illustrated as being in operable communication with three rendering frameworks 702A-C, however, it is contemplated that intermediary framework 704 can provide coordination to any number of independent rendering frameworks.

In some implementations, one or more of first rendering framework 702A, second rendering framework 702B, and third rendering framework 702C can be a framework capable of rendering both 2D and 3D content, such as in an integration framework for 2D and 3D elements. Such an integration framework can implement a two-layered application programming interface (API) system, where developers can use a declarative API to define nodes by executing one or more pre-defined functions (e.g., generating a 2D element with specific pre-defined properties) and/or an imperative API to define nodes by executing one or more functions specified for those nodes (e.g., writing a sequence of commands that code to generate a 3D element). Once an application, having been so designed, is executing, it can cause a combination of 2D and 3D elements to be rendered. This can include the rendering system obtaining a component tree including multiple nodes defined by such declarative statements or imperative commands. The nodes can include both 2D and 3D elements intermixed, and even include 2D and 3D elements at parent and child nodes with respect to each other within the component tree. Some implementations can traverse the component tree of nodes to develop a 3D world view including the 2D and 3D elements. In a first pass of traversing the component tree, some implementations can extract 2D elements while bypassing the 3D elements, and add the 2D elements onto a flat 2D canvas, such as a panel, with texture, i.e., in a renderable state. In a second pass of traversing the component tree, some implementations can extract the 3D elements from the component tree, and determine how the 2D elements and the 3D elements translate into the 3D world view, e.g., how they should be rendered. Based on the determination, some implementations can draw at least one of the 2D elements, selected from the 2D canvas, and at least one of the 3D elements, into the 3D world view. Some implementations can determine which of the 2D elements and 3D elements should be drawn into the 3D world view based on definitions existing at nodes of the component tree, such as rules specifying how and when a particular 2D or 3D element should be displayed, e.g., as a response to particular detected input, when another 2D or 3D element is output, etc. Some implementations can render the 3D world view in the XR environment via a user interface, such as on an XR device. Further details regarding an integration framework for 2D and 3D elements are described in U.S. patent application Ser. No. 18/167,478, filed Feb. 10, 2023, entitled “Integration Framework for Two-Dimensional and Three-Dimensional Elements in an Artificial Reality Environment,” which is herein incorporated by reference in its entirety.

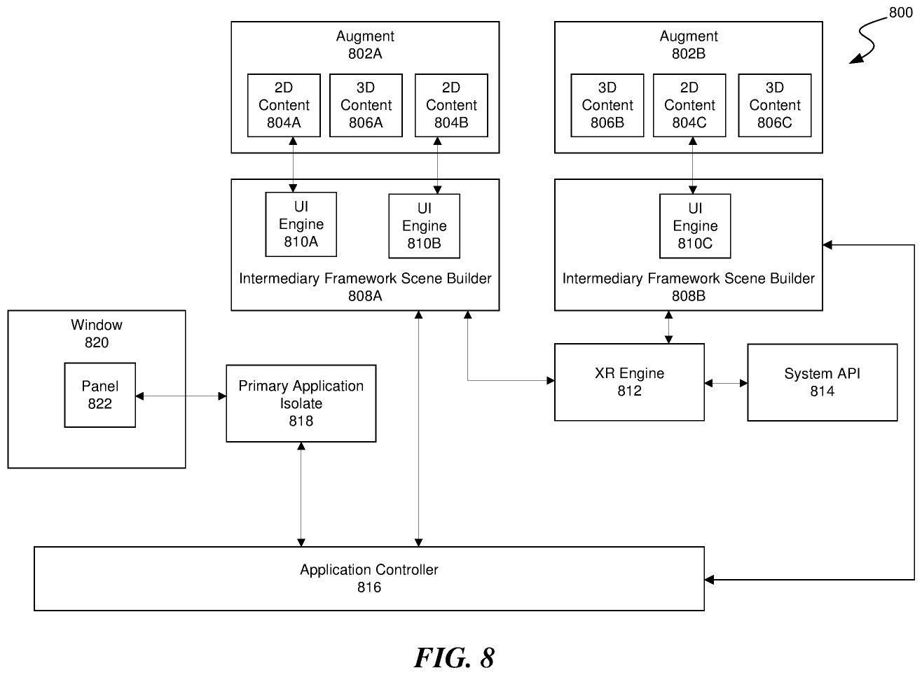

Intermediary framework 704 can include an XR engine, e.g., XR engine 812 of FIG. 8 as described further herein. Intermediary framework 704 can further be in operable communication with workflow engine 706, which can manage the workflow of intermediary framework 704 and provide real-time processing for actions without the need for code. Workflow engine 706 can be in operable communication with system API 708, which can be similar to system API 814 of FIG. 8, as described further herein.

In some implementations, intermediary framework 704 can manage platform events, platform functions, and platform textures for first rendering framework 702A, second rendering framework 702B, and third rendering framework 702C. Platform events can allow an event exposed in one framework (e.g., first rendering framework 702A) to influence the visuals, state, and/or behavior of content produced in another framework (e.g., second rendering framework 702B) via data payloads translated from the scripting language of one framework into the scripting language of another. At the other framework (e.g., second rendering framework 702B), received events can be queued in order as they're received, and drained in the same order upon execution (e.g., when the other framework decides or is ready to drain the queue). Platform functions can allow a framework using one scripting language (e.g., first rendering framework 702A) to call routines, make use of services, and/or invoke specified pre-defined functions at another framework (e.g., third rendering framework 702C) using a different scripting language. In some implementations, the platform functions can be a set of predefined functions that one framework can make to another framework via intermediary framework 704, and can thus be more structured than platform events. Unlike platform events, platform functions can be executed immediately upon receipt by the other framework. Platform textures can provide the ability for intermediary framework 704 to pass texture information back and forth from different rendering frameworks (e.g., first rendering framework 702A, second rendering framework 702B, and/or third rendering framework 702C) to the XR engine (e.g., XR engine 812 of FIG. 8), either as an actual file or as a file path to 2D and/or 3D content, which can include images and/or videos.

FIG. 8 is a block diagram illustrating an application lifecycle 800 for an intermediary framework (e.g., intermediary framework 164 of FIG. 1 and/or intermediary framework 704 of FIG. 7) that determines the relationship of system components to scene components. The scene can include augment 802A having 2D content 804A-B and 3D content 806A. The scene can further include augment 802B having 3D content 806B-C and 2D content 804C. Although illustrated and described as having two augments 802A-B, three pieces of 2D content 804A-C, and three pieces of 3D content 806A-C, it is contemplated that the scene can include any number of augments having any number of pieces of 2D and/or 3D content.

Each piece of 2D content 804A-C can be managed by its own instance of a user interface (UI) engine, i.e., 2D content 804A can be managed by UI engine 810A of intermediary framework scene builder 808A, 2D content 804B can be managed by UI engine 810B of intermediary framework scene builder 808A, and 2D content 804C can be managed by UI engine 810C of intermediary framework scene builder 808B. In this example, each augment 802A-B has a corresponding respective intermediary framework scene builder 808A-B. Intermediary framework scene builders 808A-B can be in operable communication with XR engine 812. XR engine 812 can manage all augment rendering via system API 814. XR engine 812 can be the runtime and rendering engine for rendering frameworks coordinated by the intermediary engine. System API 814 can be a standard, low-level system API upon which the scene is built. In some implementations, system API 814 can be OpenXR.

Primary application isolate 818 can control the UI in panel 822 of window 820 in the scene. Application controller 816 can be responsible for starting up primary application isolate 818 and launching new scenes. Application controller 816 can further forward application lifecycle events to primary application isolate 818.

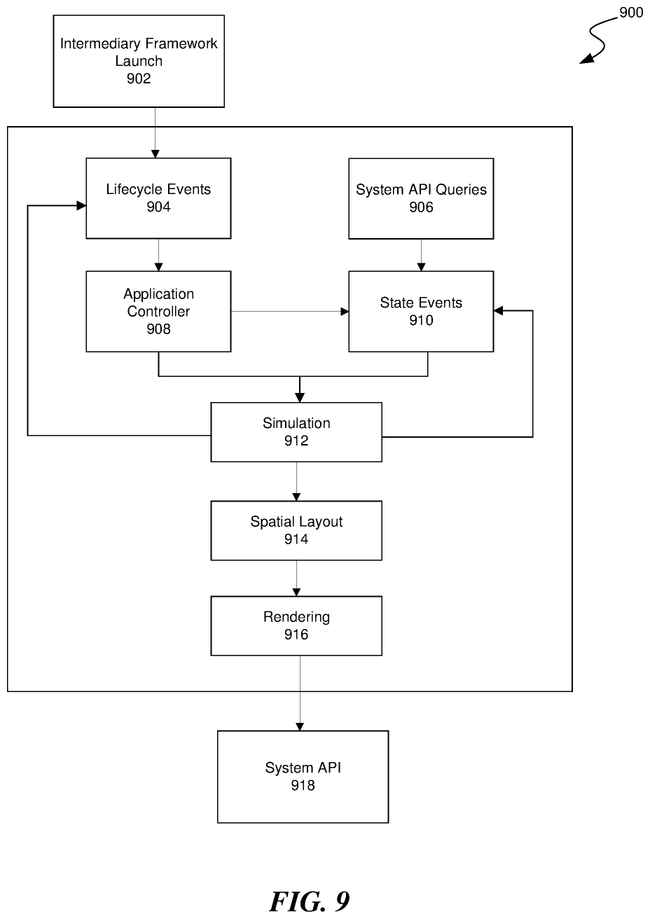

FIG. 9 is a flow diagram illustrating an update loop 900 for an intermediary framework according to some implementations. At block 902, the intermediary framework can be launched. In some implementations, the intermediary framework can be launched automatically, e.g., upon activation or donning of an XR device, e.g., an XR HMD and/or processing components in operable communication with the XR HMD. Upon launch, the intermediary framework can add plug-ins to the XR device corresponding to multiple independent rendering frameworks used to render 2D and/or 3D content on the XR HMD.

Upon launch at block 902, update loop 900 can continue to lifecycle events 904. When scene components for the XR device undergo changes that cannot be handled by a single render loop, lifecycle events 904 can track these changes asynchronously. Exemplary lifecycle events 904 can include create a block, remove a block, create a panel, remove a panel, etc. As used herein, a “block” can be a node configured to render 3D content, while a “panel” can be a node configured to render 2D content. Update loop 900 can then continue to application controller 908. Application controller 908 can manage the lifetime of rendering frameworks and node instances. Application controller 908 can handle asynchronous requests by creating and/or destroying components (e.g., rendering framework instances or isolates, XR engine instances, etc.), loading and/or unloading components (e.g., triggering loading/unloading of blocks, triggering loading/unloading of panels, etc.), etc. Application controller 908 can further queue notification events related to the asynchronous requests to be processed as state events 910 (e.g., “panel did load,” “node did load,” etc.).

System API queries 906 can query for events to be sent to particular rendering frameworks, such as by collecting inputs, collecting anchors, obtaining the view and/or projection per eye on the XR device, etc. In some implementations, system API queries 906 can require polling for inputs, such as controller pose, controller button clicks, hand tracking, etc. System API queries 906 can provide this input to state events 910. Application controller 908 and state events 910 can further provide input to simulation 912. Simulation 912 can process messages from the rendering frameworks and render each node (e.g., panel, block, etc.). Spatial layout 914 can arrange the nodes within the augment using simulation 912. In some implementations, each augment can have its own anchor that moves independently. Spatial layout 914 can be provided to rendering 916. Rendering 916 can provide multi-node and multi-augment rendering data to system API 918, which can be similar to system API 708 of FIG. 7 and/or system API 814 of FIG. 8.

FIG. 10A is a conceptual diagram illustrating an example view 1000A from an XR device including 2D and 3D content handled by disparate rendering frameworks. View 1000A can include 3D content 1002 and 2D content 1004 overlaid onto a view of real-world environment 1006. 3D content 1002 can be, for example, a 3D avatar of a user having a messaging conversation with the user of the XR device. The messaging conversation with the other user can be shown as 2D content 1004, e.g., a text conversation. 3D content 1002 and 2D content 1004 can be associated with different rendering frameworks, i.e., 3D content 1002 can be associated with a 3D rendering framework and 2D content 1004 can be associated with a 2D rendering framework. Thus, view 1000A can be managed by an intermediary framework as described herein.

FIG. 10B is a conceptual diagram illustrating an example view 1000B from an XR device in which 3D content 1002 is reactive to an event with respect to 2D content 1004. As the messaging conversation progresses from view 1000A of FIG. 10A, 2D content 1004 can include a 2D image 1008 of a gift sent by the user having the messaging conversation with the user of the XR device. In some implementations, receipt of 2D image 1008 can be an event within 2D content 1004 that a node associated with 3D content 1002 can be registered to receive, e.g., to which it is subscribed, as is described in more detail with reference to process 500 of FIG. 5. Thus, in response to receiving 2D image 1008 in 2D content 1004 (to which the node associated with 3D content 1002 is registered to receive a notification), an intermediary framework can route a notification of the receipt of 2D image 1008 to the node associated with 3D content 1002. The 3D rendering framework can then modify 3D content 1002. For example, in response to receiving 2D image 1008 as a gift, 3D content 1002 (i.e., the other user's avatar) can be rendered as surprising the user of the XR device with flowers in view 1000B.

FIG. 10C is a conceptual diagram illustrating an example view 1000C from an XR device in which 3D content 1002 is reactive to an interaction with respect to 2D content 1004. As the messaging conversation progresses from view 1000A of FIG. 10A, 2D content 1004 can include a 2D image 1008 of a gift sent by the user having the messaging conversation with the user of the XR device. The user of the XR device can use her hand 1010 to interact with 2D image 1008, e.g., to tap 2D image 1008, which can be detected by the XR device. An intermediary framework can determine the rendering framework associated with 2D image 1008, i.e., a 2D rendering framework, and translate the intersection point between hand 1010 and 2D image 1008 onto a 2D coordinate system. The intermediary framework can then route the translated intersection point and the interaction (e.g., a tap) made at the intersection point to the 2D rendering framework, as is described in more detail with respect to process 600 of FIG. 6.

In some implementations, a node associated with 3D content 1002 can be registered to receive notification of interactions with 2D image 1008. Thus, in response to receiving notification of the interaction with 2D image 1008 in 2D content 1004, the intermediary framework can route a notification of the interaction to the node associated with 3D content 1002. The 3D rendering framework can then modify 3D content 1002. For example, in response to receiving notification of the interaction with 2D image 1008, 3D content 1002 (i.e., the other user's avatar) can be rendered as surprising the user of the XR device with flowers in view 1000C.

The intermediary framework described herein can be used in a wide variety of XR applications. For example, the intermediary framework can be used to facilitate augmented calling (e.g., holograms, shared 3D games, shared 3D content, avatars, 2D content, etc.), augmented messaging (e.g., chat with expressive content in-thread, share from message thread to elsewhere, pin message thread to world space, chat with avatar animation and interaction, etc.), augmented world (e.g., decorate the real-world environment with virtual objects, interact with content from applications, create and share moments in XR, be productive in a space, information, entertainment, etc.), system functions (e.g., controlling augments regardless of distance, direction, and angle from 3D content while always facing the user, etc.), and the like.

An “augment,” also referred to herein as a “virtual container” is a 2D or 3D volume, in an artificial reality environment, that can include presentation data, context, and logic. An artificial reality system can use augments as the fundamental building block for displaying 2D and 3D content in the artificial reality environment. For example, augments can represent people, places, and things in an artificial reality environment and can respond to a context such as a current display mode, date or time of day, a type of surface the augment is on, a relationship to other augments, etc. A controller (e.g., an application controller, such as application controller 816 of FIG. 8 and/or application controller 908 of FIG. 9 as described herein) in the artificial reality system, sometimes referred to as a “shell,” can control how artificial reality environment information is surfaced to users, what interactions can be performed, and what interactions are provided to applications. Augments can live on “surfaces” with context properties and layouts that cause the augments to be presented or act in different ways. Augments and other objects (real or virtual) can also interact with each other, where these interactions can be mediated by the shell and are controlled by rules in the augments evaluated based on contextual information from the shell.

An augment can be created by requesting the augment from the artificial reality system shell, where the request supplies a manifest specifying initial properties of the augment. The manifest can specify parameters such as an augment title, a type for the augment, display properties (size, orientation, location, eligible location type, etc.) for the augment in different display modes or contexts, context factors the augment needs to be informed of to enable display modes or invoke logic, etc. The artificial reality system can supply the augment as a volume, with the properties specified in the manifest, for the requestor to place in the artificial reality environment and write presentation data into.

Augment “presentation data” can include anything that can be output by the augment, including visual presentation data, auditory presentation data, haptic presentation data, etc. In some implementations, the presentation data can be “live” such that it matches external data either by pointing to that external data or being a copy of it that is periodically updated. The presentation data can also be shared, such that a change to the external data by another user or system can be propagated to the output of the augment. For example, an augment can display live services and data while accepting interactions from users or other augments. As a more specific example, a user may select a photo shared on a social media platform to add as presentation data to an augment that is positioned on her wall. The owner of the post may modify the photo and the modified version can be shown in the augment. Additional live social media content related to the photo may also be in the augment presentation data, such as indications of “likes” or comments on the photo. The owner of the photo may also change the access rights, causing the photo to no longer display in the augment.

An augment can track a current context, based on context factors signaled to the augment by the artificial reality system. A context can include a variety of context factors such as a current mode of the artificial reality system (e.g., interactive mode, minimized mode, audio-only mode, etc.), other objects (real or virtual) in the artificial reality environment or within a threshold distance of an augment, characteristics of a current user, social graph elements related to the current user and/or artificial reality environment objects, artificial reality environment conditions (e.g., time, date, lighting, temperature, weather, graphical mapping data), surface properties, movement characteristics of the augment or of other objects, sounds, user commands, etc. As used herein an “object” can be a real or virtual object and can be an inanimate or animate object (e.g., a user). Context factors can be identified by the artificial reality system and signaled to the relevant augments. Some context factors (e.g., the current artificial reality system mode) can be automatically supplied to all augments. Other context factors can be registered to be delivered to certain augments (e.g., at creation time via the manifest or through a subsequent context factor registration call). The augment can have variables that hold context factors for which the augment has logic. All augments can inherit some of these variables from a base augment class, some of these variables can be defined in extensions of the augment class (e.g., for various pre-established augment types), or some of these variables can added to individual augments at augment creation (e.g., with the manifest) or through a later declaration. In some cases, certain context factors can be tracked by the artificial reality system, which augments can check without the artificial reality system having to push the data to individual augments. For example, the artificial reality system may maintain a time/date global variable which augments can access without the artificial reality system constantly pushing the value of that variable to the augment.

The augment's logic (defined declaratively or imperatively) can cause the augment to change its presentation data, properties, or perform other actions in response to context factors. Similarly to the variable holding context factors, the augment's logic can be specified in a base class, in an extension of the base class for augment types, or individually for the augment (e.g., in the manifest). For example, all augments can be defined to have logic to redraw themselves for different display modes, where the augment is provided different sizes or shapes of volumes to write into for the different modes. As a further example, all augments of a “person” type can have logic to provide notifications of posts by that person or incoming messages from that person. As yet another example, a specific augment can be configured with logic that responds to an area_type context factor for which the augment is registered to receive updates, where the augment responds to that context factor having an “outside” value by checking if a time context factor indicates between 6:00 am and 7:00 pm, and if so, switching to a darker display mode.

Reference in this specification to “implementations” (e.g., “some implementations,” “various implementation,” “one implementations,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for providing coordination between multiple independent rendering frameworks by an intermediary framework on an artificial reality device, the method comprising:
rendering first content associated with a first node of multiple nodes in an augment on the artificial reality device, the augment defining a bounding layout for the multiple nodes, wherein the first node is associated with a two-dimensional rendering framework of the multiple independent rendering frameworks;
rendering second content associated with a second node of the multiple nodes in the augment on the artificial reality device, wherein the second node is associated with a three-dimensional rendering framework of the multiple independent rendering frameworks;
detecting an event with respect to the first content associated with the first node in the augment;
determining that the second node, associated with the three-dimensional rendering framework, is registered to receive a notification of the event with respect to the first content associated with the first node, associated with the two-dimensional rendering framework; and
in response to determining that the second node is registered to receive the notification of the event with respect to the first content associated with the first node, routing the notification of the event to the second node of the augment, wherein the three-dimensional rendering framework modifies the second content based on the notification.

2. The method of claim 1,
wherein the event is input received by the artificial reality device, and
wherein the method further comprises:
determining that the input corresponds to the first content associated with the first node in the augment; and
in response to determining that the input corresponds to the first content associated with the first node in the augment, routing the input to the first node of the augment, wherein the two-dimensional rendering framework causes the event with respect to the first content in the first node based on the input.

3. The method of claim 2, wherein the input includes one or more of a voice command, a gesture, a point-and-pinch gesture, a selection of a physical button on the artificial reality device, a selection of a virtual button displayed on the artificial reality device, or any combination thereof.

4. The method of claim 1,
wherein the two-dimensional rendering framework is configured to render two-dimensional content, and the first content is two-dimensional content, and
wherein the three-dimensional rendering framework is configured to render three-dimensional content, and the second content is three-dimensional content.

5. The method of claim 4,
wherein the event is an action performed in the first node, and
wherein the action performed in the first node causes a corresponding action in the second node.

6. The method of claim 1, wherein, in response to the three-dimensional rendering framework modifying the second content, the two-dimensional rendering framework modifies the first content in the augment in accordance with the bounding layout.

7. The method of claim 1, wherein the second content includes audio output by the artificial reality device.

8. The method of claim 1, wherein the two-dimensional rendering framework and the three-dimensional rendering framework communicate with the intermediary framework via different scripting languages.

9. The method of claim 1, wherein the first content and the second content are attached to spatial anchors established for a real-world environment.

10. The method of claim 1,
wherein the first content and the second content are rendered within the bounding layout according to constraints enforced by the intermediary framework, and
wherein the constraints include one or more of: a size of the augment that is allocated to the first node, a size of the augment that is allocated to the second node, the size of the augment that is allocated to the first node relative to the size of the augment that is allocated to the second node, how the first content can interact with the second content, or any combination thereof.

11. The method of claim 1, wherein the three-dimensional rendering framework modifies visuals and/or behavior of the second content based on the notification.

12. A computer-readable storage medium storing instructions that, when executed by a computing system, cause the computing system to perform a process for providing coordination between multiple independent rendering frameworks by an intermediary framework on an artificial reality device, the process comprising:
rendering first content associated with a first node in an augment on the artificial reality device, wherein the first node is associated with a first rendering framework of the multiple independent rendering frameworks;
rendering second content associated with a second node in the augment on the artificial reality device, wherein the second node is associated with a second rendering framework of the multiple independent rendering frameworks, the second rendering framework providing a different dimensionality of content than the first rendering framework;
detecting an event with respect to the first node in the augment;
determining that the second node is registered to receive a notification of the event with respect to the first node; and
in response to determining that the second node is registered to receive the notification of the event, routing the notification of the event to the second node of the augment, wherein the second rendering framework modifies the second content based on the notification.

13. The computer-readable storage medium of claim 12,
wherein the first node and the second node are included in multiple nodes in the augment, and
wherein the augment defines a bounding layout for the multiple nodes.

14. The computer-readable storage medium of claim 12,
wherein the event is input received by the artificial reality device, and
wherein the process further comprises:
determining that the input corresponds to the first content associated with the first node in the augment; and
in response to determining that the input corresponds to the first content associated with the first node in the augment, routing the input to the first node of the augment, wherein the first rendering framework causes the event with respect to the first content in the first node based on the input.

15. The computer-readable storage medium of claim 12,
wherein the first rendering framework is a two-dimensional rendering framework configured to render two-dimensional content, and the first content is two-dimensional content, and
wherein the second rendering framework is a three-dimensional rendering framework configured to render three-dimensional content, and the second content is three-dimensional content.

16. The computer-readable storage medium of claim 15,
wherein the event is an action performed in the first node, and
wherein the action performed in the first node causes a corresponding action in the second node.

17. A computing system for providing coordination between multiple independent rendering frameworks by an intermediary framework on an artificial reality device, the computing system comprising:
one or more processors; and
one or more memories storing instructions that, when executed by the one or more processors, cause the computing system to perform a process comprising:
rendering first content associated with a first node in an augment on the artificial reality device, wherein the first node is associated with a first rendering framework of the multiple independent rendering frameworks;
rendering second content associated with a second node in the augment on the artificial reality device, wherein the second node is associated with a second rendering framework of the multiple independent rendering frameworks;
detecting an event with respect to the first node in the augment;
determining that the second node is registered to receive a notification of the event with respect to the first node; and
in response to determining that the second node is registered to receive the notification of the event, routing the notification of the event to the second node of the augment, wherein the second rendering framework modifies the second content based on the notification.

18. The computing system of claim 17,
wherein the first node and the second node are included in multiple nodes in the augment, and
wherein the augment defines a bounding layout for the multiple nodes.

19. The computing system of claim 17,
wherein the event is input, and
wherein the input includes one or more of a voice command, a gesture, a point-and-pinch gesture, a selection of a physical button on the artificial reality device, a selection of a virtual button displayed on the artificial reality device, or any combination thereof.

20. The computing system of claim 17, wherein the first content and the second content are attached to spatial anchors established for a real-world environment.
